(19) United States
(12) Patent Application Publication
(10) Pub. No.: US 2016/0019350 A1
(43) Pub. Date: Jan. 21, 2016

(54) VISUALLY RENDERING LONGITUDINAL PATIENT DATA

(71) Applicant: KONINKLIJKE PHILIPS N.V., EINDHOVEN (NL)

(72) Inventors: Richard Vdovjak, Eindhoven (NL); Anca Ioana Daniela Bucur, Eindhoven (NL)

(21) Appl. No.: 14/744,509

(22) Filed: Jun. 19, 2015

Related U.S. Application Data
(60) Provisional application No. 62/017,365, filed on Jun. 26, 2014.

(51) Int. Cl. G06F 19/00; H04N 21/435; H04N 5/783

(52) U.S. Cl. CPC G06F 19/322; H04N 5/783; H04N 21/435

(57) ABSTRACT

A system is provided for visually rendering longitudinal patient data. The system makes use of a screen template defining at least one visual element for being rendered on a display, with an appearance of the visual element being defined by a visualization parameter. The screen template associates the visual element with a clinical decision rule. During operation, longitudinal patient data is accessed and analyzed, namely by evaluating the clinical decision rule using a time portion of the longitudinal patient data as input to obtain a rule output, and by determining the visualization parameter of the visual element based on the rule output. The visual element is then rendered on the display in accordance with the visualization parameter, namely as part of the screen template. This yields a rendering which enables a user to more efficiently process the large amount of data provided by longitudinal patient data. Preferably, the screen template is animated based on the variation in the rule output over the different time portions of the longitudinal patient data.

### FIELD OF THE INVENTION

The invention relates to a system and a method for visually rendering longitudinal patient data using a screen template. The invention further relates to a computer readable medium comprising data representing instructions for causing a processor system to perform the method, to an authoring system for authoring the screen template, and to a computer readable medium comprising data representing the screen template.

### BACKGROUND OF THE INVENTION

Within the clinical field, clinical decision making is a complex task for which a clinician needs to process a large amount of continuously evolving information. As diagnosis and treatment selections become increasingly multifaceted, especially in complex chronic diseases such as cancer, the volume of knowledge and data that a clinician needs to combine and evaluate for a single patient is rapidly growing to an overwhelming level. In particular, the longitudinal time-span of patient data that is relevant for a given patient is increasingly large. This holds especially for long term treatments of chronic diseases. As a result, the clinician may need to simultaneously follow the evolution over time of a large number of rapidly-changing parameters to make correct diagnosis and treatment decisions.

A paper titled “Visual Exploration of Time-oriented Patient Data for Chronic Diseases: Design Study and Evaluation” by Alexander Rind et al, describes an interactive visualization system, called VisuExplore, to support long-term care and medical analysis of patients with chronic diseases. It is said that VisuExplore uses a collection of well-established visualization techniques, each of which can handle one class of time-oriented variables well. It is said that diagrams of these techniques are combined in a multiple-view visualization, where all views share a common time axis. A visual “position on a common scale” encoding is used for the time aspects of all items of all variables to allow the users to keep a common frame of reference. It is said that this enables a user to easily find out about sequence, co-occurrence, and co-development of multiple, possibly heterogeneous variables.

A drawback of the VisuExplore system is that it does not sufficiently assist the user in processing a large amount of data as provided by longitudinal patient data.

### SUMMARY OF THE INVENTION

It would be advantageous to provide a system or method which better assists the user in processing a large amount of data as provided by longitudinal patient data.

To better address this concern, a first aspect of the invention provides a system for visually rendering longitudinal patient data, comprising:

a template interface for accessing a data representation of a screen template comprising i) first data defining at least one visual element for being rendered on a display, an appearance of the visual element being defined by a visualization parameter, and ii) second data associating the visual element with a clinical decision rule;

a patient data interface for accessing longitudinal patient data;

a rule engine configured for analyzing the longitudinal patient data by:

j) accessing the clinical decision rule associated with the visual element;
jj) evaluating the clinical decision rule using a time portion of the longitudinal patient data as input to obtain a rule output;
jjj) determining the visualization parameter of the visual element based on the rule output; and

a rendering engine configured for rendering the screen template on the display, the rendering of the screen template comprising rendering the visual element in accordance with the visualization parameter.

In a further aspect of the invention, a method is provided for visually rendering longitudinal patient data, comprising:

accessing a data representation of a screen template comprising i) first data defining at least one visual element for being rendered on a display, an appearance of the visual element being defined by a visualization parameter, and ii) second data associating the visual element with a clinical decision rule;

accessing longitudinal patient data;

analyzing the longitudinal patient data by:

j) accessing the clinical decision rule associated with the visual element;
jj) evaluating the clinical decision rule using a time portion of the longitudinal
patient data as input to obtain a rule output;
jjj) determining the visualization parameter of the visual element based on the rule output; and

rendering the screen template on the display, the rendering of the screen template comprising rendering the visual element in accordance with the visualization parameter.

In a further aspect of the invention, a computer readable medium is provided, the computer readable medium comprising non-transitory data representing instructions for causing a processor system to perform the method.

The above aspects involve portions of the longitudinal patient data being visually rendered in a manner which assists the user in processing, e.g., analyzing, interpreting and/or understanding, a large amount of data as provided by longitudinal patient data. A screen template is provided which may comprise data defining at least one visual element for being rendered on a display. An example of a visual element may be a widget such as a gauge, a progress bar, etc. The visual element may be a graphical, e.g., non-textual element. However, the visual element may also comprise text matter. The visual element may take on a different visual appearance depending on a value of a visualization parameter. For example, the visualization parameter may define a color or shape of the visual element. The screen template may further comprise data associating the visual element with a clinical decision rule. Clinical decision rules are known per se from the field of clinical decision support. For example, the clinical decision rule may be obtained from a rule repository, such as a knowledge base of a clinical decision support system. Association may take various forms, such as referencing to a location of the clinical decision rule on said rule repository, or including a data representation of the clinical decision rule within the screen template.

Longitudinal patient data may be accessed, e.g., on a patient data repository. The patient data is longitudinal in that the patient data may represent different instances, spans or episodes in time. As such, the patient data may comprise different time portions. The longitudinal patient data may be obtained from, e.g., an electronic health record.

A rule engine is provided which may apply the clinical decision rule to a time portion of the longitudinal patient data to obtain a rule output. The rule output may thus represent an outcome of the clinical decision rule for the particular time instance, time span or time episode of the patient data. For example, if the clinical decision rule comprises an IF-THEN statement, the condition to the IF may be provided by data obtained from the particular time portion of the longitudinal patient data, and the THEN may provide the rule output. The clinical decision rule may be evaluated using inference techniques, as known from the field of clinical decision support. The rule engine may determine a value of the visualization parameter of the visual element based on the rule output. As such, the rule output may determine, wholly or in part, the appearance of the visual element.

A rendering engine is provided for rendering the screen template on the display. Such rendering may comprise rendering the visual element to establish the appearance in accordance with the value of the visualization parameter. The rendering may also comprise rendering other visual elements defined by the screen template. The rendering may comprise generating display data which, when displayed on the display, establishes the screen-template on screen. The display may or may not be part of the system.

The above measures have as effect that a time portion of the longitudinal patient data is visually rendered using a visual element of which the appearance changes depending on the outcome of a clinical decision rule being applied to the time portion of the longitudinal patient data. This yields a rendering which enables a user to more efficiently process the large amount of data provided by longitudinal patient data. Namely, the visual element takes on a different appearance based on a clinical decision rule-based evaluation of said data and thereby provides an intuitive visualization of the outcome of said evaluation.

Optionally, the rule engine is configured for analyzing different time portions of the longitudinal patient data to determine a time-varying visualization parameter representing a variation in the rule output over the different time portions, and the rendering engine is configured for animating the screen template by rendering the visual element in accordance with the time-varying visualization parameter. It has been found that animating the screen template by adapting the visual appearance of the visual element to the rule outcome obtained from different time portions of the longitudinal patient data is a particular advantageous way of visually rendering the longitudinal patient data.

In a further aspect of the invention, an authoring system is provided for authoring a screen template, comprising:

a rule interface for accessing a rule repository, the rule repository comprising a plurality of clinical decision rules;

a visual element storage comprising at least one visual element for being rendered on a display, an appearance of the visual element being defined by a visualization parameter;

a user interface subsystem configured for enabling a user to:

i) select a visual element from the visual element storage; and
ii) associate a clinical decision rule from the rule repository to the visual element;

a template generator configured for generating a data representation of the screen template comprising first data defining the visual element and second data associating the visual element with the clinical decision rule.

The authoring system may enable a user, such as a clinician, to generate the screen template in a convenient and intuitive manner.

In a further aspect of the invention, a computer readable medium is provided, the computer readable medium comprising non-transitory data representing a screen template, said data comprising i) first data defining a visual element for being rendered on a display, an appearance of the visual element being defined by a visualization parameter, and ii) second data associating the visual element with a clinical decision rule.

It will be appreciated by those skilled in the art that two or more of the above-mentioned embodiments, implementations, and/or aspects of the invention may be combined in any way deemed useful.

Modifications and variations of the method, the authoring system, the instructions and/or the screen template, which correspond to the described modifications and variations of the system, can be carried out by a person skilled in the art on the basis of the present description.

The invention is defined in the independent claims. Advantageous yet optional embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system for visually rendering longitudinal patient data;

FIG. 2 shows a method for visually rendering longitudinal patient data;

FIG. 3 shows a rendered screen template, and illustrates the authoring the screen template by a user selecting visual elements from a visual element library;

FIG. 4 shows a data representation of a screen template comprising first data defining a visual element and second data referencing to a clinical decision rule;

FIG. 5 illustrates the animating of the screen template based on the rule engine analyzing different time portions of the longitudinal patient data;

FIG. 6 shows an authoring system for authoring a screen template;

FIG. 7 shows a computer readable medium comprising non-transitory data representing instructions for causing a processor system to perform the method; and

FIG. 8 shows a computer readable medium comprising non-transitory data representing a screen template.

It should be noted that items which have the same reference numbers in different drawings, have the same structural features and the same functions, or are the same signals. Where the function and/or structure of such an item has been explained, there is no necessity for repeated explanation thereof in the detailed description.

### LIST OF REFERENCE NUMBERS

The following list of reference numbers is provided for facilitating the interpretation of the drawings and shall not be construed as limiting the claims.
010 template repository
11 screen template
11-13 plurality of screen templates
110 template interface
020 rule repository
21 clinical decision rule
21-23 plurality of clinical decision rules
120 rule interface
030 patient data repository
31-33 longitudinal patient data of different patients
31 longitudinal patient data of a patient
130 patient data interface
040 user input device
042 user input signal
140 user interface
51-54 plurality of visual elements
55 visual element
050 visual element selection window
150 rule engine
152 visualization parameter
160 rendering engine
162 display data
060 display
61 rendered screen template
62 playback control element
200 method for visually rendering longitudinal patient data
210 accessing screen template operation
220 accessing longitudinal patient data operation
230 analyzing longitudinal patient data operation
230A accessing clinical decision rule operation
230B evaluating clinical decision rule operation
230C determining visualization parameter operation
240 rendering screen template operation
300 authoring system
320 rule interface
350 visual element storage
360 user interface subsystem
362 display data
370 template generator
400, 402 computer readable medium
410 non-transitory data representing instructions

### DETAILED DESCRIPTION OF EMBODIMENTS

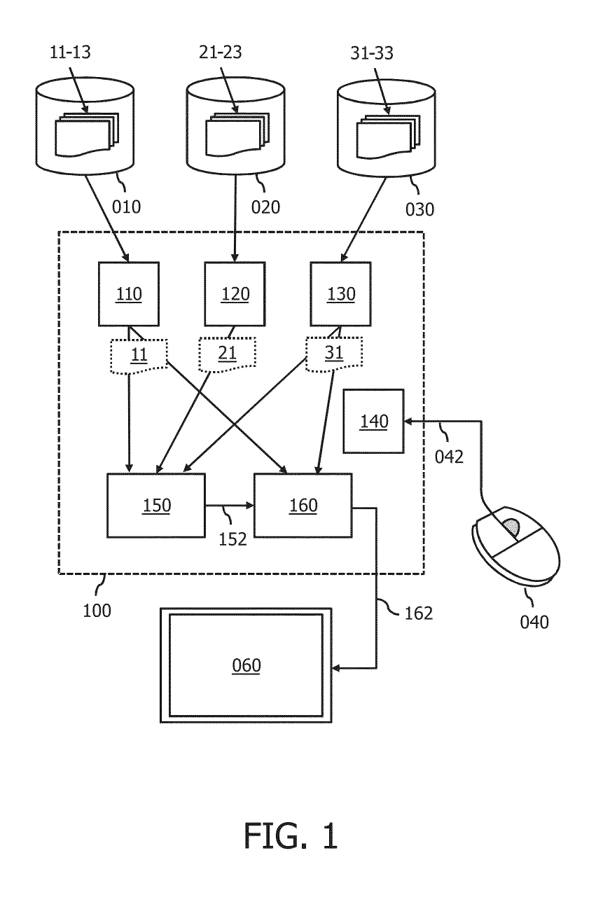

FIG. 1 shows a system 100 for visually rendering longitudinal patient data. The system 100 is shown to comprise a template interface 110 for accessing a data representation of a screen template 11. The template interface 110 is shown to be connected to a template repository 010 comprising a plurality of screen templates 11-13. Accordingly, the template interface 110 may be an external interface, such as a Local Area Network (LAN) or Wide Area Network (WAN) interface. Alternatively, the template interface 110 may be an internal interface, such as an internal storage interface to an internal storage.

The screen template 11 is represented by data. It is noted that a reference to the screen template is to be understood as reference to the data representation of the screen template where appropriate. As also further described with reference to FIG. 4, the screen template 11 comprises first data which defines at least one visual element for being rendered on a display, and second data associating the visual element with a clinical decision rule.

FIG. 1 further shows an optional aspect of the system 100, in that the system 100 is shown to comprise a rule interface 120 for accessing a rule repository 020, with the rule repository comprising a plurality of clinical decision rules 21-23. Accordingly, the screen template 11 may associate the visual element with a particular one 21 of the clinical decision rules 21-23 by referencing to the clinical decision rule 21 in the rule repository 020. However, this is not a limitation, in that said associating may also take a different form. Moreover, the visual element may be associated with more than one clinical decision rule.

The system 100 further comprises a patient data interface 130 for accessing longitudinal patient data 31. FIG. 1 shows the patient data interface 130 being connected to a patient data repository 030 comprising longitudinal patient data 31-33 of different patients. The patient data interface 130 may access the longitudinal data 31 of a particular patient. In general, the patient data interface 130 may be an external interface such as a LAN or WAN interface connected to a Hospital Information System (HIS). The longitudinal patient data 31 may be provided by, or comprised in, an Electronic Health Record (EHR). Accordingly, the patient data repository 030 may be constituted by an EHR database. However, this is not a limitation, in that the longitudinal patient data may also take any other suitable form.

The system 100 further comprises a rule engine 150 which is configured for, during an operation of the system 100, accessing the clinical decision rule 21 associated with the visual element. For that purpose, the rule engine 150 is shown to be connected to the template interface 110 and to the rule interface 120. The rule engine 150 is further configured for, during operation of the system 100, evaluating the clinical decision rule 21 using a time portion of the longitudinal patient data 31 as input to obtain a rule output, and for determining the visualization parameter 152 of the visual element based on the rule output. Here, in order to access the time portion of the longitudinal patient data 31, the rule engine 150 is shown to be connected to the patient data interface 130.

The system 100 further comprises a rendering engine 160 which is configured for, during the operation of the system 100, rendering the screen template 11 on the display 060. Here, the rendering of the screen template 11 comprises rendering the visual element in accordance with the visualization parameter 152, e.g., by suitably establishing its appearance. For that purpose, the rendering engine 160 is shown to be connected to the template interface 110 and is shown to receive the visualization parameter 152 from the rule engine 150. Moreover, the rendering engine 160 is shown to provide display data 162 to the display 060 which, when displayed thereon, establishes the rendering of the screen template 11 on screen.

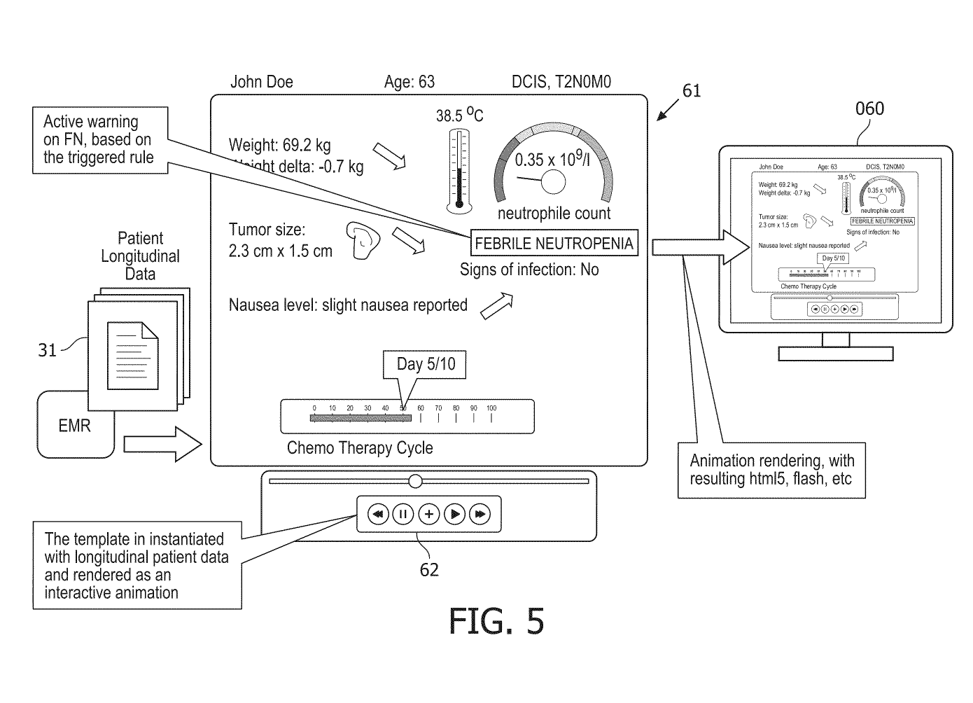

FIG. 1 further shows an optional aspect of the system 100, in that the system 100 is shown to comprise a user interface 140 for enabling a user to provide user commands 042 by operating a user input device such as a computer mouse 040, keyboard, etc. The user commands 042 may serve various purposes. For example, as will also be described with reference to FIG. 5, the user interface 140 may enable the user to request a detailed view of a currently rendered time portion of the longitudinal patient data via a user command 042.

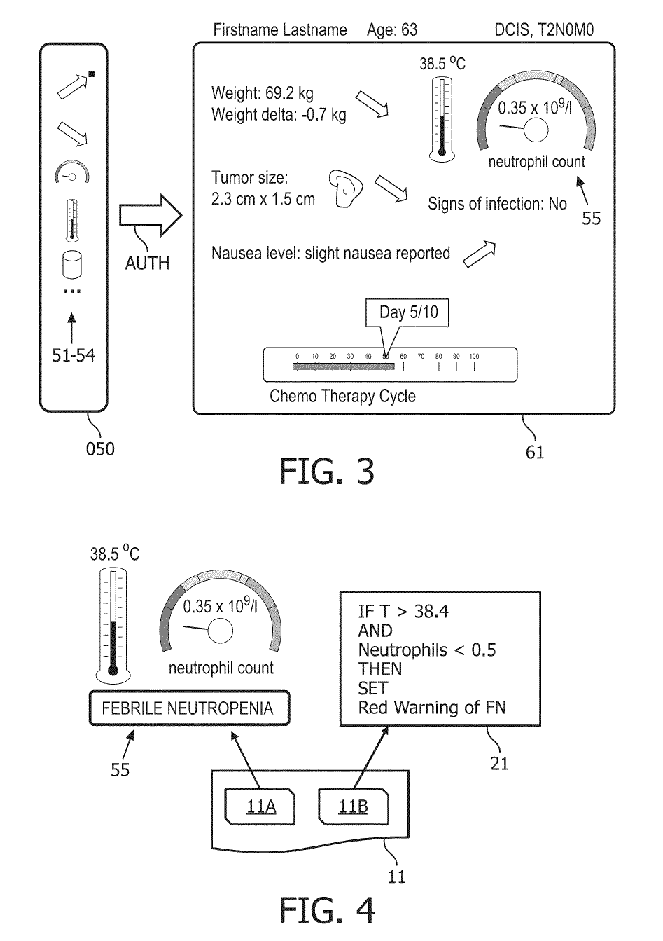

It is noted that the operation of the system 100, including various optional aspects thereof, will be further described with reference to FIGS. 3 to 5.

The system 100 may be embodied as, or in, a single device or apparatus, such as a workstation or imaging apparatus. The device or apparatus may comprise one or more microprocessors which execute appropriate software. The software may have been downloaded and/or stored in a corresponding memory, e.g., a volatile memory such as RAM or a non-volatile memory such as Flash. Alternatively, the functional units of the system may be implemented in the device or apparatus in the form of programmable logic, e.g., as a Field-Programmable Gate Array (FPGA). In general, each functional unit of the system may be implemented in the form of a circuit. It is noted that the system 100 may also be implemented in a distributed manner, e.g., involving different devices or apparatuses. For example, the distribution may be in accordance with a client-server model.

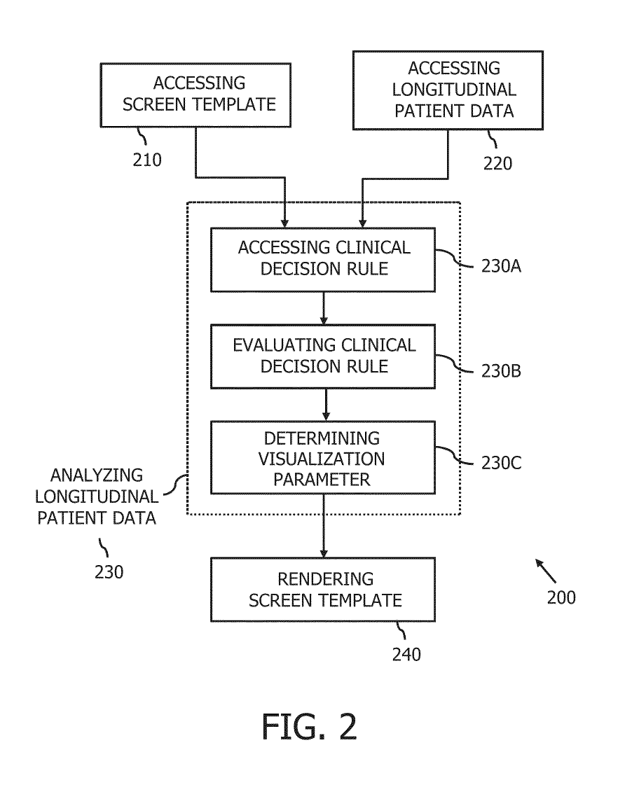

FIG. 2 shows a method 200 for visually rendering longitudinal patient data. The method 200 may correspond to an operation of the system 100 of FIG. 1. However, this is not a limitation, in that the method 200 may also be performed in separation of the system 100 of FIG. 1, e.g., using one or more different devices or apparatuses.

The method 200 comprises, in an operation titled “ACCESSING SCREEN TEMPLATE”, accessing 210 a data representation of a screen template comprising i) first data defining at least one visual element for being rendered on a display, an appearance of the visual element being defined by a visualization parameter, and ii) second data associating the visual element with a clinical decision rule. The method 200 further comprises, in an operation titled “ACCESSING LONGITUDINAL PATIENT DATA”, accessing 220 longitudinal patient data. The method 200 further comprises a set of operations 230 titled “ANALYZING LONGITUDINAL PATIENT DATA”. The set of operations 230 comprises, in an operation titled “ACCESSING CLINICAL DECISION RULE”, accessing 230A the clinical decision rule associated with the visual element, in an operation titled “EVALUATING CLINICAL DECISION RULE”, evaluating 230B the clinical decision rule using a time portion of the longitudinal patient data as input to obtain a rule output, and in an operation titled “DETERMINING VISUALIZATION PARAMETER”, determining 230C the visualization parameter of the visual element based on the rule output. The method 200 further comprises, in an operation titled “RENDERING SCREEN TEMPLATE”, rendering 240 the screen template on the display, the rendering of the screen template comprising rendering the visual element in accordance with the visualization parameter.

The method 200 may be implemented on a computer as a computer implemented method, as dedicated hardware, or as a combination of both. As also illustrated in FIG. 7, instructions for the computer, e.g., executable code, may be stored on a computer readable medium 400, e.g., in the form of a series 410 of machine readable physical marks and/or as a series of elements having different electrical, e.g., magnetic, or optical properties or values. The executable code may be stored in a transitory or non-transitory manner. Examples of computer readable mediums include memory devices, optical storage devices 400, integrated circuits, servers, online software, etc. FIG. 7 shows an optical disc.

The operation of the system of FIG. 1 and the method of FIG. 2, including various optional aspects thereof, may be explained in more detail as follows.

FIG. 3 shows an example of a rendered screen template 061, as may be rendered by the rendering engine on a display. It can be seen that the rendered screen template 061 comprises various visual elements such as arrows, gauges, a thermometer, a progress bar and text matter. The data presentation of the screen template may define the rendering in that it may define the visual elements, their appearance, their mutual positions, etc. The screen template may be authored by a user. The authoring, indicted by “AUTH” in FIG. 3, may involve the user selecting visual elements from a visual element selection window 050 and arranging them on a canvas of the screen template, e.g., via drag-and-drop.

A visual element may be associated with a part of the longitudinal patient data. For example, the textual visual element “Weight” may be associated with a weight measurement of the longitudinal patient data, causing the rendering engine to adapt the appearance of the textual visual element based on the actual weight measurement. Accordingly, the textual visual element may display a measured weight of “69.2 kg”.

A visual element may also be associated with a clinical decision rule. The appearance of the visual element may then be determined in part by one or more visual parameters which in turn are determined by the outcome of the clinical decision rule when applied to a portion of the longitudinal patient data. An example of such a visual element 055 is shown in FIG. 3, with FIG. 4 illustrating the association between the visual element 055 and a clinical decision rule. Namely, in FIG. 4, the screen template 11 is shown to comprise first data 11A defining the visual element 55 and second data 11B associating the visual element 55 with a clinical decision rule 21. For example, the first data 11A may comprise a data representation of the visual element 55 including one or more visualization parameters which determine its appearance. The second data 11B may comprise a reference to the clinical decision rule on a rule repository, e.g., by comprising a rule identifier, database index or Uniform Resource Locator (URL). Accordingly, the screen template 11 may link to the relevant sources of data to enable the screen template to be populate (instantiated) with the necessary information during rendering by the rendering engine, e.g., at run-time.

The visual element 055 as shown in FIGS. 3 and 4 is associated with a temperature measurement and neutrophil count of the longitudinal patient data as well as a clinical decision rule 21 which provides a clinical interpretation of the temperature measurement and the neutrophil count. Namely, as shown in FIG. 4, the clinical decision rule 21 may indicate that a temperature measurement above 38.4 C together with a neutrophil count below 0.5 indicates Febrile Neutropenia (FN). Accordingly, as also shown in FIG. 4, the appearance of the visual element 055 may be adjusted to display the warning text “FEBRILE NEUTROPENIA” in red, e.g., as initiated by the “SET Red Warning of FN” of the rule. In this respect, it is noted that the clinical decision rule 21 as shown in FIG. 4 directly determines the visualization parameter of the visual element. Alternatively, an additional visualization rule may be used to determine the visualization parameter based on the rule output. For example, the clinical decision rule may have as rule output “FN” or “NOT FN”, and the additional visualization rule may state “IF FN, THEN SET Red Warning of FN”. Although not shown in FIGS. 3 and 4, the visual element 055 may also be associated with a plurality of different clinical decision rules which adjust different aspects of its appearance.

It is noted that the visual element may represent a visual metaphor for the type of rule output. For example, if the rule output indicates an occurrence of fever, the visual element may depict a thermometer, with the severity of the fever being indicated by the thermometer assuming a suitable color, e.g., orange for medium and red for high. The visualization parameter may define a visual prominence of the visual element on the display. Accordingly, the rule output may result in an increased or decreased visual prominence. The visual prominence may increase in various ways, e.g., by increasing the size of the visual element, changing its color from green to orange to red, adding a warning text, etc.

It will be appreciated that the visual parameter may be a particular modifiable property of the visual element which may be comprised in the data representation of the screen template with a default value, with the rule output then being used to modify or set said value.

FIG. 5 illustratively shows an optional aspect of the system, in that the rule engine may be configured for analyzing different time portions of the longitudinal patient data to determine a time-varying visualization parameter representing a variation in the rule output over the different time portions. In addition, the rendering engine may be configured for animating the screen template by rendering the visual element in accordance with the time-varying visualization parameter. Accordingly, the system may animate the screen template based on the rule engine analyzing different time portions of the longitudinal patient data. This is shown illustratively in FIG. 5 by the rendered screen template 61 showing the current time portion as a progress bar denoting, e.g., “Day 5/10 Chemo Therapy Cycle”.

In order to animate the screen template on screen, the rendering engine may use various techniques, such as interactive HTML5 video, flash animation or another suitable rendering format. The rendering engine may be configured for adjusting a playback speed of said animating based on the rule output. For example, the rendering engine may be configured for decreasing the playback speed of said animating, e.g., to “slow down”, if the rule output indicates a clinical event in a currently rendered time portion of the longitudinal patient data. The clinical event may relate to, or be constituted by, a clinical abnormality in the longitudinal patient data. Decreasing the playback speed may be considered a form of increasing the visual prominence of the currently rendered time portion of the longitudinal patient data. The render engine may also be configured for providing user control of the playback of the animation, e.g., by the user providing suitable user commands via a user interface. For example, a user selectable, e.g., “clickable” playback control element 62 may be provided on screen, e.g., as part of the rendered screen template 61. The user interface may also enable the user to request a detailed view of a currently rendered time portion of the longitudinal patient data. For example, the visual element itself may be user selectable. In short, the rendering engine may render the screen template as a user-interactive animation.

It is noted that the screen template and/or the clinical decision rule may be indicative of a time span, and the rule engine may be configured for analyzing the different time portions of the longitudinal patient data specifically within the time span. For example, the clinical decision rule may indicate that a time span of two years into the past is relevant for a particular clinical assessment. The rule engine may analyze the longitudinal patient data within this time span, and the rendering engine may render the screen template accordingly, e.g., as an animation covering the time span and slowing down during clinical events.

It will be appreciated that the screen template of FIGS. 3 and 5 may be advantageously used in the case of an oncology patient going through pre-operative chemotherapy. Here, the weight and its trend, the variation of the temperature, the neutrophil count and variation, the volume of the tumor and its variation, as well as other possible adverse effects of treatment may be vital at each moment during tumor treatment. A clinician may need to follow not only the response to treatment but also detect possible serious adverse events as those may become life threatening. The screen template may provide a clear overview of the longitudinal patient data in so far as it is of relevance to the tumor treatment and thereby help the clinician in avoiding missing a trend in one of the vital parameters.

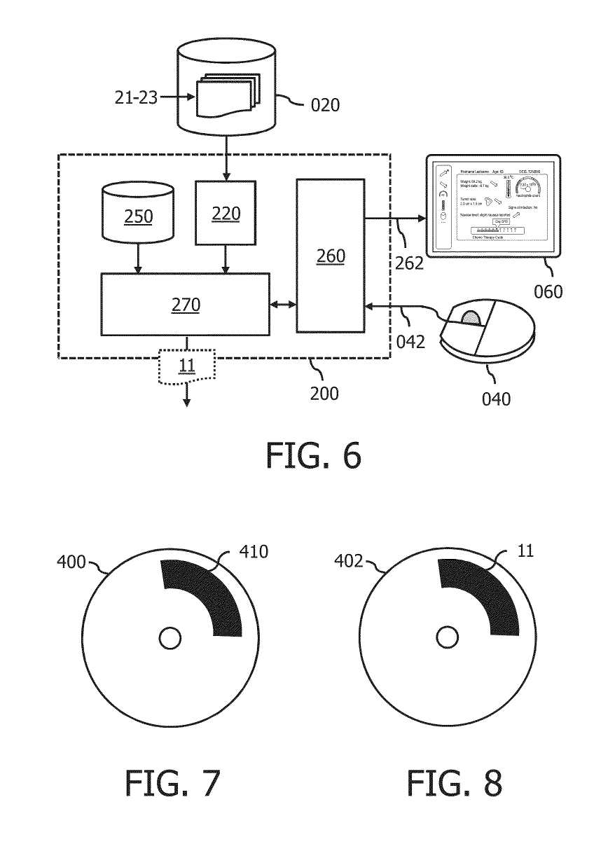

FIG. 6 shows an authoring system 200 for authoring a screen template 11 such as, but not limited to, the screen template 11 shown in FIGS. 3 and 5. The authoring system 200 may comprise a rule interface 220 for accessing a rule repository 020. The rule repository 020 may comprise a plurality of clinical decision rules 21-23. The authoring system 200 may comprise a visual element storage 250 comprising at least one visual element for being rendered on a display. Alternatively, the visual element storage may be an external storage. Likewise, alternatively, the rule repository may be an internal repository.

The authoring system 200 may further comprise a user interface subsystem 260 configured for enabling a user to i) select a visual element from the visual element storage; and ii) associate a clinical decision rule from the rule repository to the visual element. The user interface subsystem 260 may enable the user to perform said functions interactively. For that purpose, as also shown in FIG. 6, the user interface subsystem 260 may receive user commands 042 from a user input device 040 while outputting display data 262 to a display 060. The authoring system 200 may further comprise a template generator 270 configured for generating a data representation of the screen template 11 as authored by the user. Accordingly, the screen template 11 may comprise first data defining the visual element and second data associating the visual element with the clinical decision rule.

It will be appreciated that the authoring system 200 may be advantageously used to generate a screen template which includes in a single screen an intuitive and consistent representation of all relevant portions of the longitudinal patient data and as well as relevant trends at a given moment in time. For example, the authoring environment may include a library of pre-defined visual metaphors such as gauges, progress bars, and tailored-made graphics such as a thermometer. The user may drag-and-drop such visual elements onto the screen template's canvas and specify the connectivity details, e.g., in the form of an SQL query to the underlying longitudinal patient data that is to be linked to the particular visual element, a reference to a clinical decision rule, data thresholds whenever required, etc. It is further noted that the screen template may be stored in a template repository (not shown) for further later use, e.g., its visual rendering. The template repository may be updated by adding or removing screen templates or by modifying existing screen templates.

FIG. 7 shows a computer readable medium 400 comprising non-transitory data 410 representing instructions for causing a processor system to perform the method of FIG. 2. Accordingly, the computer readable medium may constitute a computer program product.

FIG. 8 shows a computer readable medium 402 comprising non-transitory data 11 representing a screen template. The data representing the screen template may comprise:

i) first data defining a visual element for being rendered on a display, an appearance of the visual element being defined by a visualization parameter, and
ii) second data associating the visual element with a clinical decision rule.
Accordingly, the computer readable medium may constitute a computer program product.

It will be appreciated that the invention as claimed may be advantageously used in the following scenario. Patient history is seen as playing an essential role in clinical decision making. The availability of a long term patient file, rich in detailed and multifaceted patient information, is seen as crucial for the proper management of the patient. In addition, a certain disease event is nowadays no longer observed or treated in isolation and long term follow-up is deemed necessary to evaluate the outcome of treatments. As such, there is a focus on creating a comprehensive overview, as accurate as possible, of a patient's health status over an increasingly long period of time. However, these needs are not supported by the traditional way of managing data in the healthcare domain, where data is preserved in independent silos of information and where each of the sources and relevant health data parameters need to be inspected separately in the corresponding system. Moreover, because of the time-pressure in the healthcare system, clinicians are able to spend less and less time per patient, and thereby need to digest more information in less time.

As such, a clinician needs to cope with increasingly overwhelming amounts of heterogeneous, complex and (rapidly) changing data and knowledge, and out of this data he/she must extract, combine and reason about (only) those portions that are relevant for the clinical management of each patient at the given time. Therefore, solutions are desired which enable clinicians to efficiently obtain an overview of a patient's complex status and of the change of this status (e.g. trends over time) at different relevant points in time.

The invention as claimed may be advantageously used to provide an intuitive and interactive visual presentation of longitudinal patient data to support the clinical decision maker to efficiently follow the multi-dimensional evolution of the patient's condition. Based on screen templates, the system may render individual comprehensive snapshots in time, combining them into an interactive animation. The system may integrate, in one screen template, all the chosen relevant clinical parameters at a given time. The system may further show the relative change compared to a previous measurement. The system may also enable the clinician to navigate through the animation of time-snapshots visualizing the patient's state, thereby enabling the clinician to spot relevant trends and important changes.

A clinician is thought to become familiar with the screen template, with the individual elements of the screen template preserving their location on the screen while their values evolves in time and are animated based on the longitudinal patient data. The values of such elements can be represented graphically by various visual metaphors such as gauges, progress bars but also tailored-made graphics such as a visual representation of a thermometer. In doing so, the clinician may easily identify trends and important changes. The clinician may play an entire selected longitudinal path like a sequence, in an animation/video, but he/she may also interact with the animation, e.g., zooming to a given moment to retrieve the underlying data and moving the animation backward and forward in time.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for visually rendering longitudinal patient data, comprising:
a template interface for accessing a data representation of a screen template comprising i) first data defining at least one visual element for being rendered on a display, an appearance of the visual element being defined by a visualization parameter, and ii) second data associating the visual element with a clinical decision rule;
a patient data interface for accessing longitudinal patient data;
a rule engine configured for analyzing the longitudinal patient data by:
j) accessing the clinical decision rule associated with the visual element;
jj) evaluating the clinical decision rule using a time portion of the longitudinal patient data as input to obtain a rule output;
jjj) determining the visualization parameter of the visual element based on the rule output; and
a rendering engine configured for rendering the screen template on the display, the rendering of the screen template comprising rendering the visual element in accordance with the visualization parameter.

2. The system according to claim 1, wherein:
the rule engine is configured for analyzing different time portions of the longitudinal patient data to determine a time-varying visualization parameter representing a variation in the rule output over the different time portions; and
the rendering engine is configured for animating the screen template by rendering the visual element in accordance with the time-varying visualization parameter.

3. The system according to claim 2, wherein the rendering engine is configured for adjusting a playback speed of said animating based on the rule output.

4. The system according to claim 3, wherein the rendering engine is configured for decreasing the playback speed of said animating if the rule output indicates a clinical event in a currently rendered time portion of the longitudinal patient data.

5. The system according to any one of claims 2 to 4, wherein the screen template and/or the clinical decision rule are indicative of a time span, wherein the rule engine is configured for analyzing the different time portions of the longitudinal patient data within the time span.

6. The system according to any one of claims 2 to 5, further comprising a user interface for enabling a user to control playback of said animating.

7. The system according to claim 6, wherein the user interface is configured for enabling the user to request a detailed view of a currently rendered time portion of the longitudinal patient data.

8. The system according to any one of claims 1 to 7, further comprising a rule interface for accessing a rule repository, the rule repository comprising a plurality of clinical decision rules, wherein the second data of the data representation of the screen template comprises a reference to the clinical decision rule in the rule repository.

9. The system according to any one of claims 1 to 8, wherein the template interface is configured for accessing the screen template on a template repository, the template repository comprising a plurality of screen templates, the system further comprising a selection mechanism for selecting the screen template from the plurality of screen templates.

10. The system according to any one of claims 1 to 9, wherein the visual element represents a visual metaphor for the type of rule output.

11. The system according to any one of claims 1 to 10, wherein the visualization parameter defines a visual prominence of the visual element on the display.

12. A method for visually rendering longitudinal patient data, comprising:
accessing a data representation of a screen template comprising i) first data defining at least one visual element for being rendered on a display, an appearance of the visual element being defined by a visualization parameter, and ii) second data associating the visual element with a clinical decision rule;
accessing longitudinal patient data;
analyzing the longitudinal patient data by:
j) accessing the clinical decision rule associated with the visual element;
jj) evaluating the clinical decision rule using a time portion of the longitudinal patient data as input to obtain a rule output;
jjj) determining the visualization parameter of the visual element based on the rule output; and
rendering the screen template on the display, the rendering of the screen template comprising rendering the visual element in accordance with the visualization parameter.

13. A computer readable medium comprising non-transitory data representing instructions for causing a processor system to perform the method according to claim 12.

14. An authoring system for authoring a screen template, comprising:
a rule interface for accessing a rule repository, the rule repository comprising a plurality of clinical decision rules;
a visual element storage comprising at least one visual element for being rendered on a display, an appearance of the visual element being defined by a visualization parameter;
a user interface subsystem configured for enabling a user to:
i) select a visual element from the visual element storage; and
ii) associate a clinical decision rule from the rule repository to the visual element;
a template generator configured for generating a data representation of the screen template comprising first data defining the visual element and second data associating the visual element with the clinical decision rule.

15. A computer readable medium comprising non-transitory data representing a screen template, said data comprising i) first data defining a visual element for being rendered on a display, an appearance of the visual element being defined by a visualization parameter, and ii) second data associating the visual element with a clinical decision rule.
